(19) United States
(12) Patent Application Publication
(10) Pub. No.: US 2014/0073163 A1
(43) Pub. Date: Mar. 13, 2014

(54) WATERPROOF CONNECTOR

(71) Applicant: YAZAKI CORPORATION, TOKYO (JP)

(72) Inventors: Hiroshi Kojima, Makinohara-shi (JP); Shinichi Saeki, Makinohara-shi (JP)

(73) Assignee: YAZAKI CORPORATION, Tokyo (JP)

(21) Appl. No.: 14/082,411

(22) Filed: Nov. 18, 2013

Related U.S. Application Data
(63) Continuation-in-part of application No. PCT/JP2012/061949, filed on May 10, 2012.

(30) Foreign Application Priority Data
May 19, 2011 (JP) 2011-111996

(51) Int. Cl. H01R 13/52

(52) U.S. Cl. CPC H01R 13/5205
USPC 439/275

(57) ABSTRACT

An object is to provide a waterproof connector which can prevent an electric wire from being removed and which can reduce number of components, An engagement hole is provided at a housing portion of a housing, and a lance is provided at a rubber stopper containing resin. When the lance and the engagement hole are engaged to each other, the rubber stopper containing resin is fixed within the housing.

### TECHNICAL FIELD

The present invention relates to a waterproof connector which prevents water and such from entering into a housing.

### BACKGROUND ART

As disclosed in Patent Literature 1, for example, a waterproof connector includes a housing having a plurality of terminal housing chambers for housing a terminal connected to an end of an electric wire, and a cover body as a waterproof member arranged to be attached to a rear end portion of the housing at which the respective terminal housing chambers open. The cover body includes a seal portion for making the rear end portion of the housing watertight and a holder portion arranged to be engaged with and fixed to the rear end portion of the housing.

Another example of a conventional waterproof connector is explained below in reference to FIG. 3. FIG. 3 is a cross-sectional view showing a rear end portion of a waterproof connector 101. The waterproof connector 101 includes a housing 102, a terminal 103, a rubber stopper 104 containing resin, and a rear holder 105.

The housing 102 is formed of insulating resin and such and includes a terminal housing chamber 102a for housing the terminal 103, a housing portion 102b located at a rear side of the terminal housing chamber and into which the rubber stopper 104 containing resin is inserted. The terminal 103 is formed of conductive metal and is electrically-connected to an electric wire 106 which is not shown in FIG. 3.

The rubber stopper 104 containing resin includes a tubular portion 104a formed into a tubular shape by resin, and a seal portion 104b formed by an elastic member for sealing such as rubber. The tubular portion 104a is inserted into the housing portion 102b and allows the electric wire 106 to pass through the tubular portion. The seal portion 104b is formed into a ring shape. A part of the seal portion 104b arranged on an inner side of the tubular portion 104a is closely-attached to the electric wire 106, and a part of the seal portion 104b arranged on an outer side of the tubular portion 104a is closely-attached to the housing portion 102b.

The rear holder 105 includes a cover portion 105a positioned at a rear portion of the housing portion 102b, and an engagement portion 105b extending from an end of the cover portion 105a and arranged to be engaged with an outer circumferential portion of the housing 102. The cover portion 105a is provided with a through hole for passing the electric wire 106 therethrough. The engagement portion 105b is provided with an engagement portion not shown to be engaged with the housing 102.

### CITATION LIST

### Patent Literature

Patent Literature 1: Japan Patent Application Publication No. 2006-179416

### SUMMARY OF INVENTION

### Problem to be Solved

However, the structure shown in FIG. 3 requires the rear holder 105 to fix the rubber stopper 104 containing resin within the housing portion 102b. Furthermore, since this rear holder 105 is arranged to be engaged with and retained at the outer circumference of the housing 102, the rear holder 105 is fitted in a press-fitting fashion during an assembling. Thus, there is possibility that the engagement portion 105b is damaged, and in this case, the rubber stopper 104 containing resin cannot be fixed, and thus the electric wire 106 may be removed.

Furthermore, the waterproof connector disclosed in Patent Literature 1 requires, for example, a lance and a retaining mechanism for retaining the lance at a retaining position in the housing, causing an increase in size of the housing.

In view of the above-mentioned problems, an object of the present invention is to provide a waterproof connector which can prevent an electric wire from being removed, which can reduce number of components, and which can downsize a housing.

### Solution to Problem

In order to achieve the above-described object, the present invention provides, in a first aspect, a waterproof connector including: a housing having a terminal housing chamber arranged to house a terminal connected to an electric wire; and a waterproof member provided at a rear end portion of the housing and formed into a tubular shape to pass the electric wire through a tubular, portion of the waterproof member, wherein the housing includes a housing portion arranged to house the waterproof member, and wherein the waterproof member includes a first seal portion arranged to be closely-attached to the electric wire at an inner side of the tubular portion of the waterproof member, a second seal portion arranged to be closely-attached to the housing portion at an outer side of the tubular portion of the waterproof member, and an engagement portion arranged to be engaged with the housing portion in the housing portion.

In order to achieve the above-described object, the present invention provides, in a second aspect, the waterproof connector described above, wherein the tubular portion of the waterproof member is formed of resin, and the first seal portion and the second seal portion are formed of an elastic member.

In order to achieve the above-described object, the present invention provides in a third aspect, the waterproof connector described above, wherein the engagement portion is formed as an elastically-deformable lance having a projection projecting toward the housing, and wherein the housing portion includes a hole arranged to be engaged with the projection.

In order to achieve the above-described object, the present invention provides, in a fourth aspect, the waterproof connector described above, wherein an end portion of the waterproof member is abutted on a rear end portion of the terminal to retain the terminal.

### Advantageous Effects of Invention

As explained above, according to the invention described in the first aspect, the waterproof member includes the first seal portion arranged to be closely-attached to the electric wire and the second seal portion arranged to be closely-attached to the housing and further includes the engagement portion arranged to be engaged with the housing portion of the housing in the housing portion. Thus, the waterproof member itself functions to engage with the housing, thus there is no need to provide a rear holder, so the number of components can be reduced. Furthermore, since the waterproof member is housed in the housing, a portion for the engagement can be prevented from being damaged, thereby preventing the electric wire from being removed.

According to the invention described in the second aspect, a rear holder is not required even for the rubber stopper containing resin such as the one shown in FIG. 3, which is constituted of the tubular member formed of resin and the seal member formed of an elastic member such as rubber attached to the tubular member. Thus, number of components can be reduced, as well as a portion for the engagement can be prevented from being damaged, thereby preventing the electric wire from being removed.

As explained above, according to the invention described in the third aspect, the engagement portion is formed as the elastically-deformable lance having the projection projecting toward the housing, and the housing portion includes the hole arranged to be engaged with the projection. Thus, at the time of housing the waterproof member in the housing, the lance is elastically-deformed to make the projection engaged with the hole. Thus, the lance which can elastically-deform is prevented from being damaged, thereby preventing the electric wire from being removed.

As explained above, according to the invention described in the fourth aspect, the terminal is retained by the end portion of the waterproof member being abutted on the rear end portion of the terminal. Thus, it is not necessary to provide a mechanism for retaining the terminal to the housing, thereby downsizing the housing.

### BRIEF DESCRIPTION OF DRAWINGS

FIG. 1 is a perspective view of a waterproof connector according to one embodiment of the present invention;

FIG. 2 is a cross-sectional view showing a rear end portion of a waterproof connector shown in FIG. 1; and

FIG. 3 is across-sectional view showing a rear end portion of a conventional waterproof connector.

### DESCRIPTION OF EXEMPLARY EMBODIMENTS

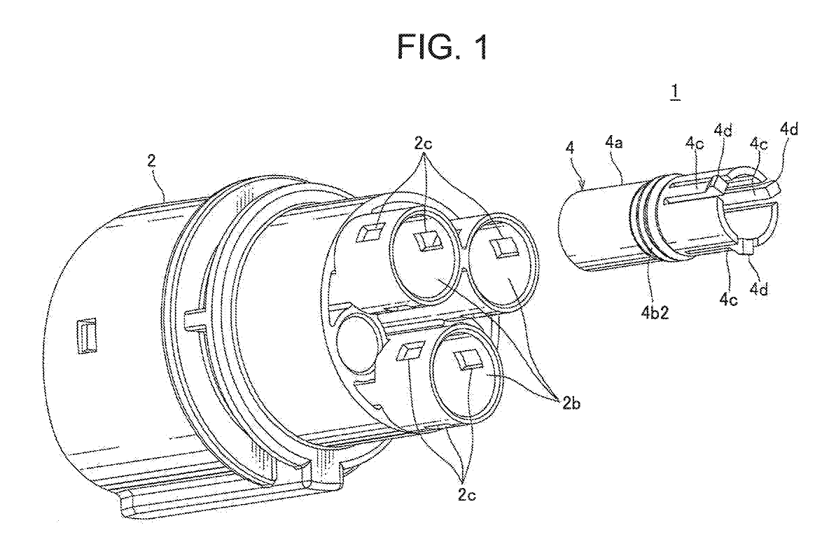

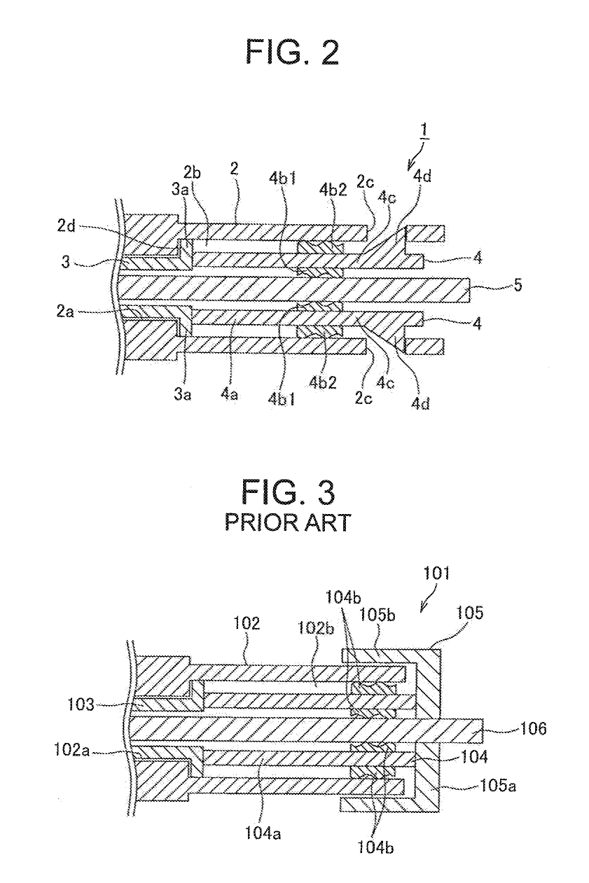

In the following, one embodiment of the present invention is explained in reference to FIG. 1 and FIG. 2. As shown in FIG. 1 and FIG. 2, a waterproof connector 1 according to one embodiment of the present invention includes a housing 2, a terminal 3 and a rubber stopper 4 containing resin.

As shown in FIG. 1, the housing 2 is formed into a substantially circular tube-like shape by insulating resin and such. As shown in FIG. 2, the housing 2 includes a terminal housing chamber 2a arranged to house the terminal 3, and a housing portion 2b arranged to house the rubber stopper 4 containing resin. The housing portion 2b provided at an end portion (i.e. a rear end portion) of the housing 2 and formed into a circular tube-like shape. In FIG. 1, the housing portions 2b are formed at three locations. The housing portion 2b includes an engagement hole 2c arranged to engage with a later-described lance 4c of the rubber stopper 4 containing resin. In FIG. 1, the engagement holes 2c are provided at three locations per one housing portion 2b.

The terminal housing chamber 2a is formed so as to communicate with the housing portion 2b, as shown in FIG. 2. Also, the terminal housing chamber 2a is formed into a tube having a diameter smaller than a diameter of the housing portion 2b. A step portion 2d is formed at a boundary between the terminal housing chamber 2a and the housing portion 2b.

The terminal 3 is formed of conductive metal and is electrically-connected to an electric wire 5 which is not shown in FIG. 2. The terminal 3 includes a flange formed at an end portion 3a and protruding in a direction perpendicular to a longitudinal direction of the electric wire 5. This end portion 3a (i.e. the flange) is arranged to be in contact with the step portion 2d.

The rubber stopper 4 containing resin as a waterproof member includes a tubular portion 4a formed into a substantially circular tube-like shape by resin, a seal portion 4b1, 4b2, and a lance 4c. The tubular portion 4a has a diameter which is sized to pass the electric wire 5 therethrough, arranged smaller than a diameter of the housing portion 2b of the housing 2, and sized such that the end portion 3a of the terminal 3 can be pushed with one end portion of the tubular portion 4.

The tubular potion 4a includes the lance 4c as an engagement portion formed adjacent to the other end of the tubular portion 4a. The lance 4c is extending fro ear a central portion of the tubular portion 4a toward the other end along the longitudinal direction. The other end is a free end and is elastically deformable in directions toward and away from (i.e. directions to be contacted with and separated from) the electric wire 5 which is passed through the tubular portion 4a. A projection 4d is formed at this free end and is projecting toward the housing portion 2b (i.e. the housing 2) so as to engage with the engagement hole 2c of the housing portion 2b. As shown in FIG. 1, the lances 4c are provided at three locations per rubber stopper 4 containing resin so as to correspond with the engagement holes 2c. The tubular portion 4a and the lance 4c are integrally-formed together.

The seal portions 4b1, 4b2 are disposed at a location nearer the one end of the tubular portion 4a than the lance 4c. The seal portions 4b1, 4b2 are formed into a ring-like shape by an elastic member for sealing such as rubber. The seal portion 4b1 as a first seal portion provided at an inner side of the tubular potion 4a is arranged to be closely-attached to the electric wire 5, and the seal portion 4b2 as a second seal portion provided at an outer side of the tubular portion 4a is arranged to be closely-attached to the housing portion 2b.

The waterproof connector 1 having the above-described structure may be assembled as described below. Firstly, the electric wire 5 is passed through the rubber stopper 4 containing resin so the electric wire 5 and the terminal 3 a electrically-connected to each other. Then, the terminal 3 is inserted into the terminal housing chamber 2a of the housing 2 from the side of the housing portion 2b, and then the rubber stopper 4 containing resin is inserted into the housing portion 2b of the housing 2.

At this time, the lance 4c of the rubber stopper 4 containing resin is elastically-deformed in the direction toward the electric wire 5 shown in FIG. 2, and the projection 4d enters into the housing portion 2b. When the projection 4d has entered to the location of the engagement hole 2c, the lance 4c is elastically-restored in the direction away from the electric wire 5, and thus the projection 4d is engaged with the engagement hole 2c, and the rubber stopper 4 containing resin is fixed within the housing portion 2b. Furthermore, when the rubber stopper 4 containing resin is fixed within the housing portion 2b, the one end of the rubber stopper 4 containing resin (i.e. the end adjacent to the terminal 3 in FIG. 2) comes to a stop against (i.e. abuts on) an end portion 3b of the terminal 3 and retains the terminal 3.

Furthermore, while the rubber stopper 4 containing resin is in the fixed state, the seal portion 4b is positioned nearer the one end (i.e. nearer the terminal) than the lance 4c, and the seal portion 4b1 is closely-attached to the electric wire 5 and the seal portion 4b2 is closely-attached to the housing portion 2b (i.e. the housing 2). Thus, the seal portion 4b can function as a waterproof member which prevents water from entering from an opening or the engagement hole 2c of the housing portion 2b.

According to this embodiment, the engagement hole 2c is provided at the housing portion 2b of the housing 2, and the lance 4c is provided at the rubber stopper 4 containing resin, and the rubber stopper 4 containing resin is fixed within the housing 2 by making the projection 4d of the lance 4c engaged with the engagement hole 2c. Thus, there is no need to provide a rear holder, and thus number of components can be reduced. Furthermore, the rubber stopper 4 containing resin is provided with the engagement hole 2c into which the projection 4d enters. Thus, when the rubber stopper 4 containing resin is housed within the housing 2, the lance 4c is elastically-deformed and the projection 4d is engaged with the engagement hole 2c. Thus, since the lance 4c can elastically-deform, the lance 4c can be prevented from being damaged, thereby preventing the electrical wire 5 from being removed.

Moreover, since the end portion 3a of the terminal 3 is pushed by the rubber stopper 4 containing resin, there is no need to provide a mechanism for retaining the terminal 3 within the housing 2. Thus, the housing 2 can be downsized.

In the embodiment described above, the rubber stopper 4 containing resin is described as a waterproof member. However, the waterproof member may be arranged such that, it is entirely formed of an elastic member such as rubber, that its outer side can be closely-attached to the housing, that it includes a projection and such as a engagement portion so it can be fixed, that an electric wire is passed there inside, and that it can be closely-attached to the electric wire. In this case, since the entire rubber stopper can be formed as one piece by rubber and such, an assembling of the waterproof member itself can be omitted, thereby reducing the cost.

The embodiments described herein are only representative embodiment of the present invention, and the present invention is not limited to these. That is, the present invention can be modified in various ways and implemented without departing from the gist of the present invention.

### REFERENCE SIGN LIST

1 waterproof connector
2 housing
2a terminal housing chamber
2b housing portion
2c engagement hole (hole)
3 terminal
4 rubber stopper containing resin (waterproof member)
4b seal portion
4c lance (engagement portion)
4d projection
5 electric wire

1. A waterproof connector comprising:
a housing having a terminal housing chamber arranged to house a terminal connected to an electric wire; and
a waterproof member provided at a rear end portion of the housing and formed into a tubular shape to pass the electric wire through a tubular portion of the waterproof member,
wherein the housing includes a housing portion arranged to house the waterproof member, and
wherein the waterproof member includes
a first seal portion arranged to be closely-attached to the electric wire at an inner side of the tubular portion of the waterproof member,
a second seal portion arranged to be closely-attached to the housing portion at an outer side of the tubular portion of the waterproof member, and
an engagement portion arranged to be engaged with the housing portion in the housing portion.

2. The waterproof connector according to claim 1, wherein the tubular portion of the waterproof member is formed of resin, and the first seal portion and the second seal portion are formed of an elastic member.

3. The waterproof connector according to claim 1,
wherein the engagement portion is formed as an elastically-deformable lance having a projection projecting toward the housing, and
wherein the housing portion includes a hole arranged to be engaged with the projection.

4. The waterproof connector according to claim 2,
wherein the engagement portion is formed as an elastically-deformable lance having a projection projecting toward the housing, and
wherein the housing portion includes a hole arranged to be engaged with the projection.

5. The waterproof connector according to claim 1, wherein an end portion of the waterproof member is abutted on a rear end portion of the terminal to retain the terminal.

6. The waterproof connector according to claim 1, wherein the waterproof member is entirely formed of an elastic member and is entirely formed as one piece.

7. The waterproof connector according to claim 6,
wherein the engagement portion is formed as an elastically-deformable lance having a projection projecting toward the housing, and
wherein the housing portion includes a hole arranged to be engaged with the projection.

8. The waterproof connector according to claim 6, wherein an end portion of the waterproof member is abutted on a rear end portion of the terminal to retain the terminal.

9. The waterproof connector according to claim 2, wherein an end portion of the waterproof member is abutted on a rear end portion of the terminal to retain the terminal.

10. The waterproof connector according to claim 3, wherein an end portion of the waterproof member is abutted on a rear end portion of the terminal to retain the terminal.

11. The waterproof connector according to claim 4, wherein an end portion of the waterproof member is abutted on a rear end portion of the terminal to retain the terminal.

12. The waterproof connector according to claim 7, wherein an end portion of the waterproof member is abutted on a rear end portion of the terminal to retain the terminal.
